(19) United States
(12) Patent Application Publication
(10) Pub. No.: US 2017/0335262 A1
(43) Pub. Date: Nov. 23, 2017

(54) APPARATUS AND METHODS FOR INCREASED TIME RATES AND FLAVOR CONTROL IN THE AGING OF ALCOHOLIC BEVERAGES

(71) Applicants: William Blair, Tucson, AZ (US); Nathan Chorover, Tucson, AZ (US)

(72) Inventors: William Blair, Tucson, AZ (US); Nathan Chorover, Tucson, AZ (US)

(21) Appl. No.: 15/161,293

(22) Filed: May 23, 2016

(51) Int. Cl. C12G 3/07; C12H 1/18; C12H 1/16

(52) U.S. Cl. CPC C12G 3/065; C12H 1/165; C12H 1/18

(57) ABSTRACT

A method and system for rapidly aging ethanol-based solutions is disclosed wherein the temperature of a mass transfer column containing packing material is controlled while fluid flows there through.

### CROSS-REFERENCE TO RELATED APPLICATIONS

This application claims the benefit of U.S. Provisional Patent Application No. 62/165,399, filed May 22, 2015, the entire contents of which are incorporated by reference.

### FIELD OF THE INVENTION

The embodiments herein relate to a packed column reactor for increased time rates and flavor control in the aging of alcoholic spirits.

### BACKGROUND

The alcoholic beverage industry is a multi-billion-dollar business. Within the industry, the higher end beverages are almost inevitably the aged products that have matured to a characteristic aroma and taste over a long period of time, which, traditionally takes years or even decades.

The flavor of aged of wine and spirits distinguishes alcohol from most other consumable goods. Alcohol is perishable and capable of deteriorating and complex chemical reactions can alter the aroma, color, mouth-feel and taste of the alcohol over time in a way that may be more pleasing to the taster. This ability of an alcohol to age well is influenced by many factors. The condition that the alcohol is kept in during aging can also influence how well an alcohol ages and may require significant time and financial investment.

Some alcohols do not mature in the bottle, only in the cask, so the “age” of the alcohol is [symbol] The barrels and the interaction between the oak and the alcohol is one of the most interesting components of the production process. The quality of the barrels is carefully monitored because the new spirit is to gain body, character, and color from the process. Some casks will have been previously used. The type of barrel used for maturation is classically determined by the Master Blender. Previously, only after a minimum of three-years maturation can the alcohol spirit be properly aged. In practice, however, in order to improve taste, most alcohols are matured for much longer—from five to fifteen, twenty, or twenty-five years.

### SUMMARY OF INVENTION

[symbol] only the time between distillation and bottling.

The embodiments herein relate to methods of aging alcohol using a mass transfer column that accepts alcohol through an inlet and allows the alcohol to saturate a material, which, for example, may be a mixture of fruit bits, wood chips, and/or other items.

In some embodiments, the alcohol is pumped at a sinusoidal rate, enhancing the process. The flow of alcohol into the column can be controlled to oscillate it in order to better age the alcohol. In some embodiments, the mass transfer column has a gas inlet for gas to be pumped into the column such that the alcohol would be infused with a gas chosen by the user. The solution could also be irradiated by having a system of electromagnetic wave generators surrounding the column such that electromagnetic waves penetrate throughout the columns to irradiate the solution as it passes through the column. Also, the temperature of the solution can be controlled to an ideal temperature by using a heat jacket that surrounds the mass transfer column.

Ultimately, a solution that would normally take years to decades to age could be done with the methods and system described herein to achieve the same result in a small fraction of the time and for a fraction of the cost.

### BRIEF DESCRIPTION OF DRAWINGS

FIG. 1 schematically depicts a system for aging an ethanol-based solution.

FIG. 2 depicts the elongated mass transfer column.

FIG. 3 depicts another embodiment of the elongated mass transfer column.

FIG. 4 depicts an elongated mass transfer column with a heat jacket and vapor stream.

FIG. 5 depicts an elongated mass transfer column with an irradiation system.

FIG. 6 is a flow diagram illustrating an example of operations for aging an ethanol-based solution in accordance with one embodiment of the present invention.

### DETAILED DESCRIPTION

The apparatus and methods described herein enable a system for aging an ethanol-based solution that allows for a shorter aging period and increased flavor profile. For instance, the aging system allows a user to control the variables pertaining to the characteristics (e.g., smell, taste, color) of various ethanol based solutions (e.g., whiskey, scotch, rum).

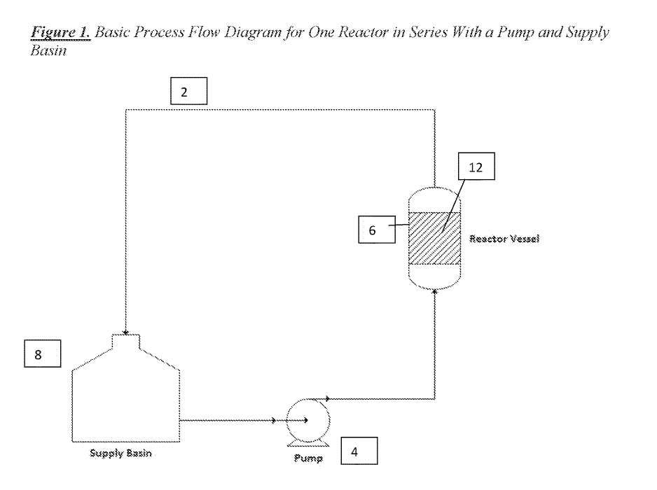

FIG. 1 is a schematic depicting an example system set-up for aging in which the configuration allows for the user to control the flow of fluid through an mass transfer column 6, in accordance with one or more aspects of the present disclosure. In the example of FIG. 1, aging system 2 may include one or more fluid flow pumps 4, one or more elongated mass transfer columns 6, a flow valve 10 before and/or after the fluid ports associated with the mass transfer column 6, and a fluid reservoir 8.

In the example of FIG. 1, the fluid reservoir 8 is configured to receive a solution from a system operator. For example, the solution may be an ethanol-based solution. Once the fluid reservoir 8 receives a certain amount of a predetermined solution, the system is configured in a closed-loop manner such that the solution can be circulated and re-circulated throughout the system based on user commands. The user commands, for example, could be such that the flow rate, flow direction, and flow duration is controlled by a machine operator or through an automatic means (e.g., computer control).

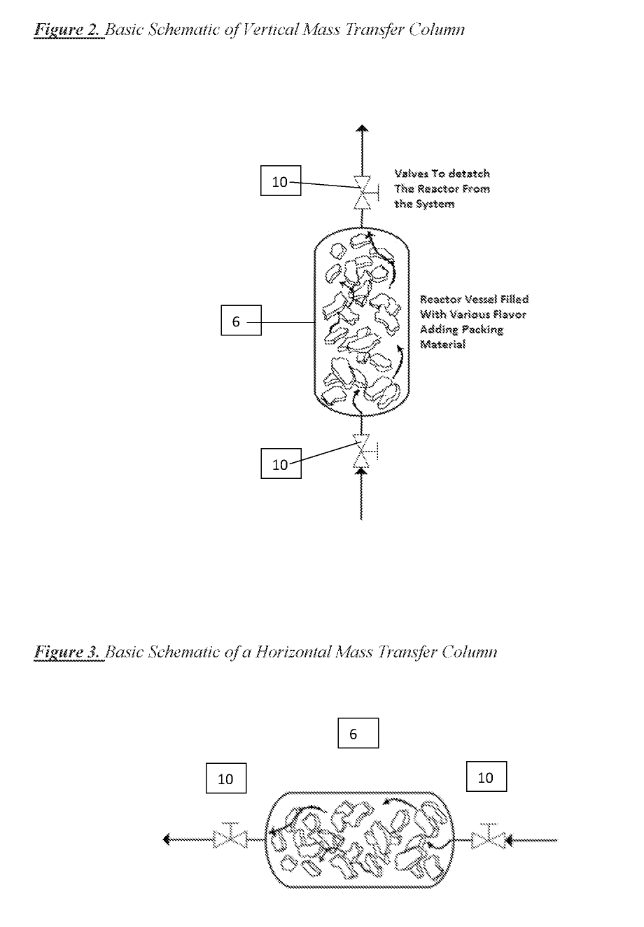

In the example of FIG. 1, the aging system 2 includes one or more mass transfer columns which will be described in further detail in FIG. 2. The one or more mass transfer columns 6, for example, may be connected in parallel by a flow distribution means. The flow distribution means can be a series of tubing or piping that establishes a fluid connect to move the solution through the system. The flow of the solution into each mass transfer column will be controlled or regulated by use of a screen protected valve 10 (e.g., stopcock or ball valve, switch, clamp, insert). For example, the flow into each mass transfer columns 6 may be regulated by one or more fluid flow pumps 4. The fluid flow pumps 4 may have the ability to control or regulate the flow direction, flow rate, or flow duration. The variable flow of the solution into the transfer column will change the flow patterns throughout the packing material 12.

In the example of FIG. 1, a user may choose to stop the flow of the solution into one or more of the elongated mass transfer columns 6. The user may do so by flipping a switch which, for example, cuts off flow to the selected elongated mass transfer column 6. In the example of having the elongated mass transfer columns 6 connected in parallel, the ability to cut off flow to a selected mass transfer column 6 allows for convenient removal of that selected mass transfer column without having to stop the system flow. In the example of FIG. 1, the elongated mass transfer columns 6 has a flow inlet for the solution and a flow outlet for the aged solution.

In the example of FIG. 1, the flow may be controlled such that the fluid flow into each mass transfer columns 6 oscillates. In one example, the flow oscillates sinusoidally, in other words, the fluid flow will increase at an increasing rate until it has reached a maximum flow rate at which point the flow will decrease at a decreasing rate until it has reached the minimum flow rate. The fluid flow rate will continue to oscillate sinusoidally until commanded otherwise by the user who may choose a more constant or reverse flow rate depending on desired characteristics of the solution. Moreover, the pump may be configured to reverse direction of flow such that a “back and forth” motion is created to thereby increase the complexity of interaction of the fluid with the packing material in the column. Thus, for example, sinusoidal, peristaltic, reversible, and other types of pumps may be used.

The example of FIG. 1 represents one embodiment of a system where a solution can be controlled and regulated to flow therethrough. The elongated mass transfer columns 6 may be connected in parallel to facilitate removal and replacement of the columns without having to discontinue flow through the remaining mass transfer columns in the system.

FIG. 2 is a diagram illustrating an example mass transfer column 6 (“column 6”) in accordance with one or more techniques of the present disclosure. In the example of FIG. 2, column 6 is cylindrical with a hollow center to allow for fluid to flow therethrough. For example, the flow of the solution may enter through the top and exit toward the bottom. In another example, the flow of the solution may enter through the bottom and exit toward the top. In other words, the column 6 may be oriented such that the flow of the fluid therethrough is assisted by gravity or flows opposite gravity.

As shown in the example of FIG. 2, the column 6 may have a flow stopping means on the inlet and outlet of the column. The flow stopping means may be a valve or pump that allows the fluid to enter into the column at a specified rate. The valve or pump may be electrically actuated by a control system or manually by a specified user.

As shown in the example of FIG. 2, the column 6 may be configured to contain different materials that are utilized in the aging process. The materials, for example, could be wood chips. Once fluid enters into the column 6, the materials will be immersed in the fluid until it exits the column 6 through the exit.

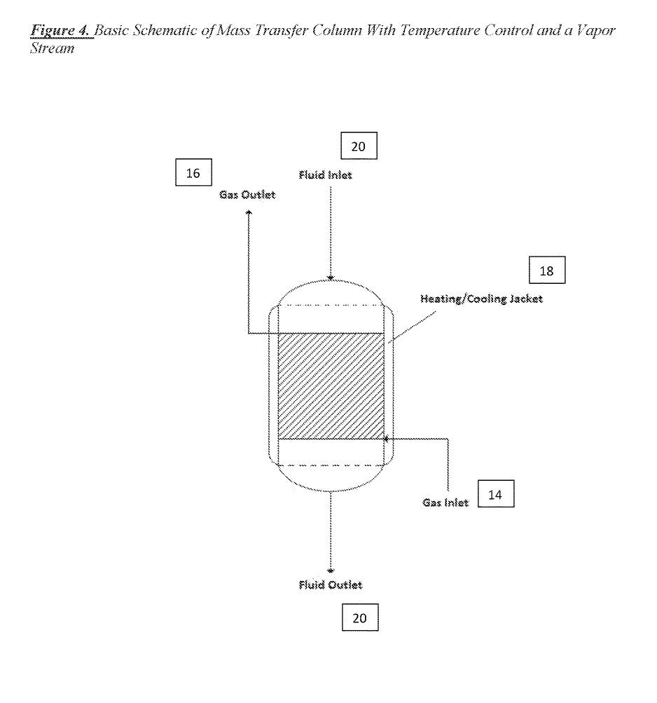

In the example of FIG. 3, the elongated mass transfer column 6 (“column 6”) may be oriented horizontally such that the fluid could enter in from either side (i.e., against the flow of gravity) and exit out the other side. The operation of the column 6 may be the same as described in FIG. 2, where the column 6 is oriented such that the flow of the fluid is with gravity.

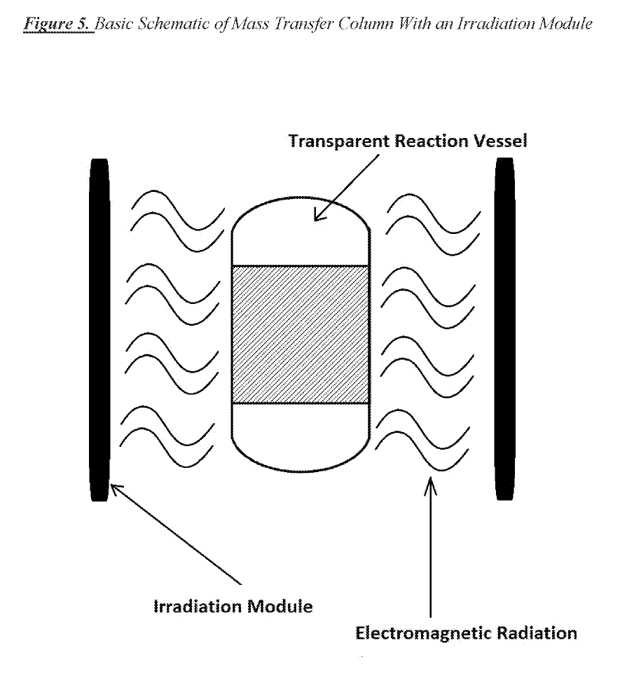

In the example of FIG. 4, the diagram illustrates an example of a mass transfer column where the mass transfer column has a gas inlet 14 such that a gas of the user's choice may be infused with the ethanol solution to add flavor to the final product. The mass transfer column may be configured with a gas outlet 16 (i.e., pressure release valve) or the pressure release valve can be positioned downstream of the fluid exit port 20 flow-stopping means of the mass transfer column. In another example, the pressure release valve can be positioned upstream the fluid exit port.

FIG. 4 additionally depicts a heat jacket 18 that envelops the mass transfer column. As shown, the heat jacket may be any material whose temperature can be regulated or contains insulation. The heat jacket 18 will be wrapped around the mass transfer column to insulate the column from the outside air and increase the temperature of the ethanol solution.

As shown in the example of FIG. 5, the mass transfer column 6 is exposed to electromagnetic cells of a wavelength ideal for irradiating the ethanol based solution.

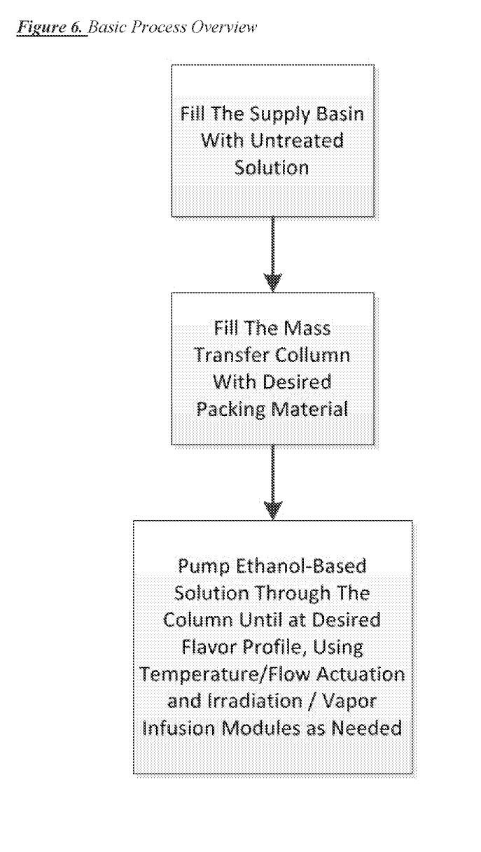

FIG. 6 is an example of a flow chart of the method for aging of the ethanol-based solution. The user begins with filling the supply reservoir with the ethanol based solution. Next the user fills an elongated mass transfer column with a material of one or any combination of wood chips, charred wood chips, citrus fruit peels, and mixture of herbs and spices, copper, or inert fillings. Finally, the method is carried out by pumping the ethanol-based solution from the supply reservoir to and through said mass transfer column and back into said supply reservoir, preferably with a flow rate that oscillates sinusoidally.

What is claimed is:

1. A system that rapidly ages an ethanol-based solution, comprising:
a. b. c. [symbol]
d. [symbol]
a mass transfer column containing a packing material, said mass transfer column having a fluid inlet and a fluid exit;
a supply reservoir in fluid connection with said fluid inlet of said mass transfer column so as to allow fluid flow from said supply reservoir to said fluid inlet; a pump configured to move said ethanol-based solution from said supply reservoir into said fluid inlet, through said mass transfer column, and out through said fluid exit; and
a temperature control apparatus to control the temperature of the ethanol-based solution within the system.

2. The system of claim 1, further including a fluid connection between the fluid exit of said column and the supply reservoir.

3. The system of claim 1, wherein said pump is further configured to move said ethanol-based fluid sinusoidally within said column.

4. The system of claim 1, further including an electromagnetic radiation apparatus configured to irradiate said ethanol-based solution.

5. The system of claim 1, wherein the mass transfer column has a gas inlet and a gas exit such that the solution can be infused with a gas.

6. The system of claim 1, further comprising a valve configured to control flow into said column, out of said column, or both.

7. A method for rapidly aging an ethanol-based solution comprising:
pumping said ethanol-based solution from a supply reservoir to and through a mass transfer column containing a material with a flow rate that oscillates sinusoidally.

8. The method of claim 7, wherein the direction of flow through the mass transfer column is contrary to gravity.

9. The method of claim 7, further comprising varying a temperature of the ethanol-based solution up to the boiling point of ethanol.

10. The method of claim 7, further comprising introducing a gas into the mass transfer column.

11. The method of claim 7, wherein said ethanol-based solution is re-circulated through said column.

12. The method of claim 7, further comprising irradiating the solution as it moves through the system with electromagnetic radiation.

13. A method for rapidly aging an ethanol-based solution comprising the steps of: pumping said ethanol-based solution from a supply reservoir to and through a mass transfer column containing a material wherein the direction of flow is contrary to gravity.

14. The method of claim 13 further comprising introducing a gas into the mass transfer column.

15. The method of claim 13, further comprising varying a temperature of the ethanol-based solution up to the boiling point of ethanol.

16. The method of claim 13, wherein said ethanol-based solution is re-circulated through said column.

17. The method of claim 13, further comprising irradiating the solution as it moves through the system with electromagnetic radiation.

18. The method of claim 13, wherein said ethanol-based solution is pumped from said supply reservoir to and through said mass transfer column and back into said supply reservoir with a flow rate that oscillates sinusoidally.
